(19) United States
(12) Patent Application Publication
(10) Pub. No.: US 2023/0347421 A1
(43) Pub. Date: Nov. 2, 2023

(54) LASER GUIDES AND METHODS OF DRILLING HOLES WITH DRILLING EQUIPMENT USING LASER GUIDES

(71) Applicant: Michael J. Underwood, Chesterton, IN (US)

(72) Inventor: Michael J. Underwood, Chesterton, IN (US)

(21) Appl. No.: 18/308,331

(22) Filed: Apr. 27, 2023

Related U.S. Application Data
(60) Provisional application No. 63/335,492, filed on Apr. 27, 2022.

(51) Int. Cl. B23B 51/00; B25H 1/00

(52) U.S. Cl. CPC B23B 51/0054; B25H 1/0071; B25H 1/0092

(57) ABSTRACT

Laser guides and methods of using the laser guides in conjunction with drilling equipment to accurately produce holes in workpieces. Such a laser guide includes a body, a laser source configured to generate a laser beam, a first end of the body configured to be releasably coupled to the spindle of the drilling machine, and a second end of the body configured to emit the laser beam such that the laser beam is axially aligned with an axis of rotation of the spindle of the drilling machine when the first end is coupled to the spindle.

### CROSS-REFERENCE TO RELATED APPLICATIONS

This application claims the benefit of U.S. Provisional Application No. 63/335,492, filed Apr. 27, 2022, the contents of which are incorporated herein by reference.

### BACKGROUND OF THE INVENTION

The present invention generally relates to drilling equipment. The invention particularly relates to a laser guide for aligning a spindle of a drilling machine with a workpiece to promote location accuracy when drilling a hole in the workpiece with the drilling machine.

Drilling equipment are used for boring holes into workpieces formed of various materials, including but not limited to metal. A conventional drilling machine generally includes a base, a column protruding upwards from the base, a drill head secured to an upper portion of the column, and a spindle protruding from the drill head toward the table. Typically, a motor (e.g., electric or pneumatic) is operable to rotate the spindle and a drill bit (or other tool) coupled thereto. The spindle may be moved vertically relative to the column to drive the rotating drill bit into the workpiece and thereby bore the hole therein. While drill presses typically comprise a table coupled to the column to support a workpiece, magnetic drilling machines lack a table and instead have a magnetic base that enables the drilling machine to be magnetically secured to the workpiece to be drilled. Magnetic drilling machines are portable and commonly used when performing maintenance, repairs, and construction, for example, at industrial sites, where the drilling machines may be required to be magnetically attached to large metal structures at various angles other than horizontal.

Magnetic drilling machines are often required to precisely and repeatably produce holes in workpieces. However, it can be challenging to accurately locate and secure a magnetic drilling machine on a workpiece relative to the drill bit such that a hole can be accurately drilled in a specific, desired position of the workpiece. Various guides have been developed over the years to promote ease of aligning workpieces relative to the drill bit of a drilling machine. Recently, guides have been provided that emit one or more laser beams intended to assist a user in positioning a workpiece to a drill press. Such guides, referred to herein as laser guides, may be components of the drilling machine or may be accessories configured to be coupled to the drilling machine.

Laser guides for drilling equipment are typically configured to emit one or more laser beams from one or more positions on the drill head directed toward a workpiece at an angle relative to the axis of rotation of the spindle. The laser beams produce a laser spot or an “x” (i.e., at an intersection of a pair of line laser beams) to designate a location on the workpiece where the drill bit will contact upon lowering the spindle. Laser guides of these types may require calibration prior to use to ensure that the position designated by the laser beam is aligned with the drill bit. Such calibration may be cumbersome, susceptible to human error, and/or provide limited precision. In addition, vibrations produced during operation of the drilling machine may cause movement of the laser guides requiring repeat subsequent calibration, or may limit their usefulness entirely (e.g., if the laser spot or “x” is moving).

In view of the above, it can be appreciated that there are certain problems, shortcomings or disadvantages associated with existing laser guides for drilling equipment, especially magnetic drilling machines that must be physically lifted and magnetic secured to a workpiece. Therefore, it would be desirable if a laser guide were available for aligning a spindle of a drilling machine relative to a workpiece in a manner that at least partly overcame or avoided the problems, shortcomings, or disadvantages noted above.

### BRIEF DESCRIPTION OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, laser guides and methods of using the laser guides in conjunction with drilling equipment to accurately produce holes in workpieces.

According to an aspect of the invention, a laser guide is provided for a drilling machine. The laser guide includes a body, a laser source configured to generate a laser beam, a first end of the body configured to be releasably coupled to the spindle of the drilling machine, and a second end of the body configured to emit the laser beam such that the laser beam is axially aligned with an axis of rotation of the spindle of the drilling machine when the first end is coupled to the spindle.

According to another aspect of the invention, a method is provided for drilling a predetermined portion of a workpiece with a portable magnetic drilling machine. The method includes locating and magnetically securing the portable magnetic drilling machine in a first position relative to the workpiece, coupling a first end of a laser guide to a spindle of the portable magnetic drilling machine, and providing power from a power source to a laser source of the laser guide so as to generate a laser beam with the laser source. While the first end of the laser guide is secured to the spindle, the laser beam is emitted from a second end of the laser guide. The laser beam is axially aligned with an axis of rotation of the spindle of the portable magnetic drilling machine and radiates a spot on the workpiece with the laser beam. If necessary, the portable magnetic drilling machine may be relocated relative to the workpiece such that the spot of the laser beam is radiated on the predetermined portion of the workpiece. Thereafter, the first end of the laser guide is decoupled from the spindle of the portable magnetic drilling machine, a drill bit can be coupled to the spindle of the portable magnetic drilling machine, and the portable magnetic drilling machine can be operated to produce a hole in the predetermined portion of the workpiece with the drill bit.

Technical effects of the laser guide and method described above preferably include the ability to position a spindle of a drilling machine relative to a workpiece to produce a hole in a predetermined position on the workpiece in a manner that promotes ease of use, accuracy, repeatability, and/or portability.

Other aspects and advantages of this invention will be appreciated from the following detailed description.

### BRIEF DESCRIPTION OF THE DRAWINGS

FIG. 1 represents a side view of a laser guide for a drilling machine in accordance with certain nonlimiting aspects of the invention.

FIG. 2 represents a fragmentary side view of the laser guide of FIG. 1 and illustrates the laser guide emitting a laser beam from an end thereof.

FIG. 3 represents a side view of a first member of the laser guide of FIG. 1.

FIG. 4 represents a perspective end view of the first member of the laser guide of FIG. 1.

FIGS. 5A and 5B represent side views of a second member of the laser guide of FIG. 1 in assembled and disassembled states, respectively.

FIGS. 6A and 6B represent perspective views of opposite ends of a laser guide according to another nonlimiting embodiment.

FIG. 7 represents a perspective view of the laser guide of FIG. 1 coupled to the spindle of a portable magnetic drilling machine and illustrates a nonlimiting method of positioning a drill bit of the portable magnetic drilling machine relative to a location on a workpiece where a hole is desired by using a spot of the laser beam emitted from the laser guide.

FIG. 8 represents a perspective view of a workpiece having a cavity in which a hole is to be drilled using the portable magnetic drilling machine of FIG. 7, wherein the center of the cavity is illuminated by the spot generated by the laser guide of FIG. 7.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

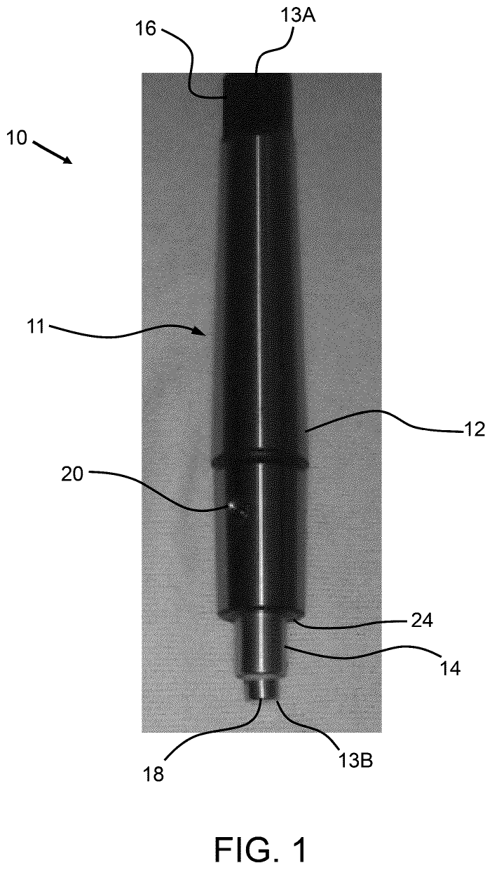

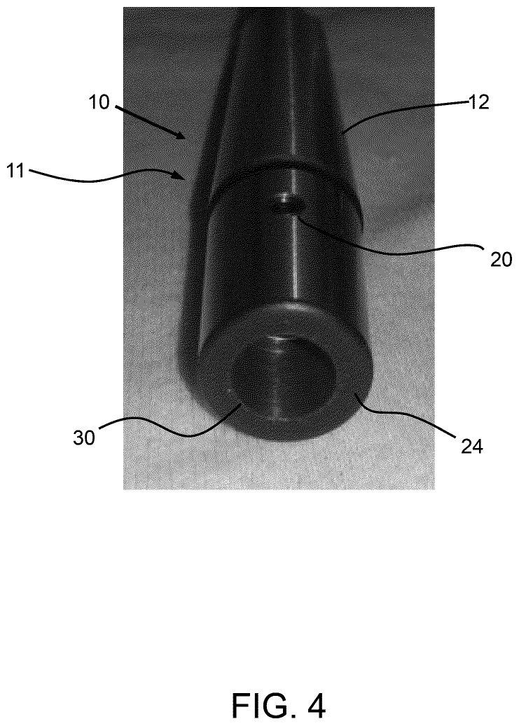

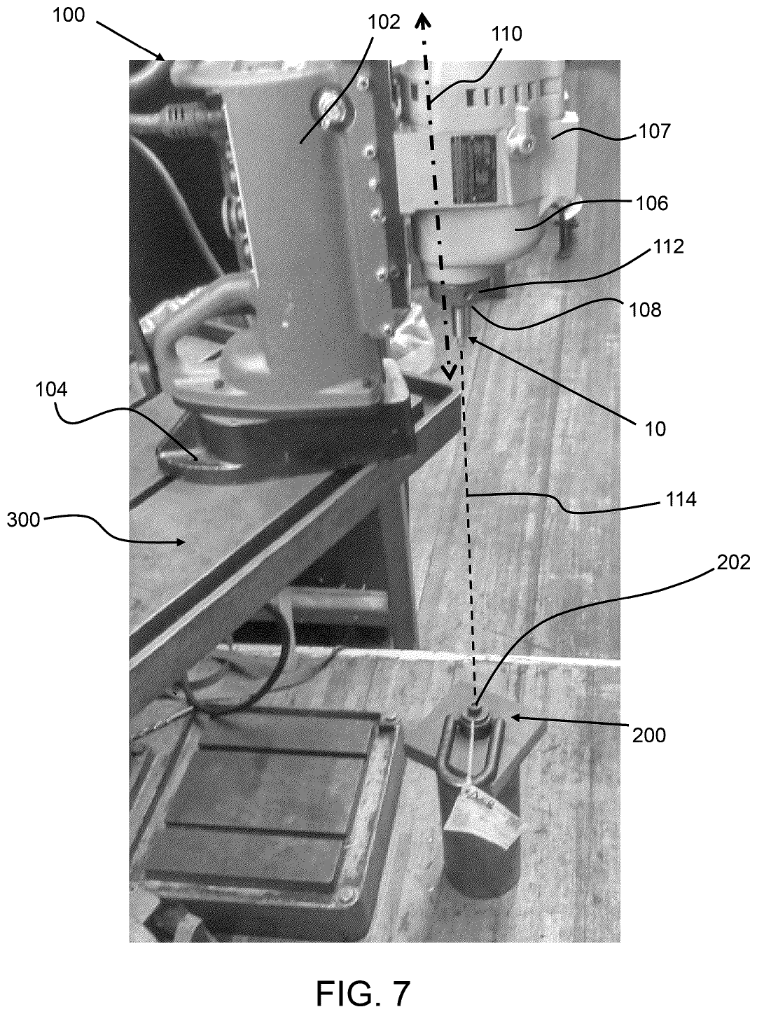

FIGS. 1 through 6B represent nonlimiting embodiments of laser guides 10 configured for use with drilling machines, and especially portable magnetic drilling machines including but not limited to the type shown in FIG. 7. The laser guides 10 may be used as a guide for positioning the path of travel of a drill bit coupled to a spindle of the drilling machine in relation to a location on a workpiece where a drilled hole is desired. Typically, the path of travel of the drill bit is in alignment with an axis of rotation of the spindle.

For convenience, the laser guides 10 will be discussed hereinafter in reference to a commercially-available portable magnetic drilling machine 100 shown in FIG. 7, which is depicted as comprising a column 102 (or pillar) protruding from a magnetic base 104, a drill head 106 secured to the column 102, and a spindle 108 protruding from the drill head 106. The drill head 106 is mounted to the column 102 for translation relative to the column 102 along what is referred to herein as a translation axis 110 of the machine 100 that is depicted as generally vertical in FIG. 7. The drill head 106 includes an electric motor 107 configured to rotate the spindle 108 about an axis of rotation 114 thereof that is parallel to the translation axis 110 of the machine 100 and perpendicular to the lower surface of the base 104. A chuck 112 may be used to releasably couple a tool (e.g., a drill bit) to the spindle 108 for rotation therewith. The drill head 106 may include a handle, such as a quill feed (not shown) to controllably transition the spindle 108 relative to the column 102, thereby allowing the tool to be translated toward and away from a workpiece 200 and, for purposes of drilling a hole, place the tool in contact with the workpiece 200.

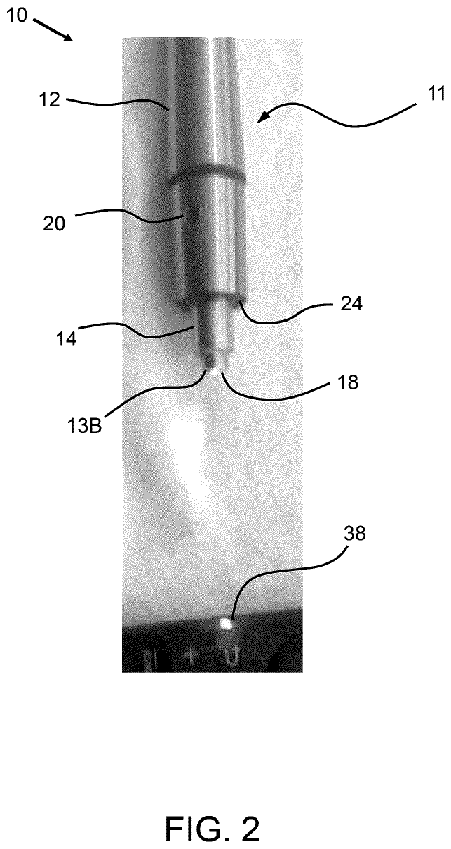

FIGS. 1 through 5B depict a laser guide 10 and components thereof in accordance with a first embodiment. The laser guide 10 is represented as including an elongate body 11 having a first end 13A and a second end 13B, wherein the first end 13A is capable of being releasably coupled to the spindle 108 of the drilling machine 100 and the second end 13B is configured to emit a laser beam therefrom (FIG. 2). When the laser guide 10 is coupled to the spindle 108 as shown in FIG. 7, the emitted laser beam is directed toward the workpiece 200 along an axial path coaxially aligned (and more preferably coinciding) with the axis of rotation 114 of the spindle 108 of the drilling machine 100. As such, a laser spot 38 produced thereby will always accurately locate a position of a drill bit subsequently secured to the spindle 108.

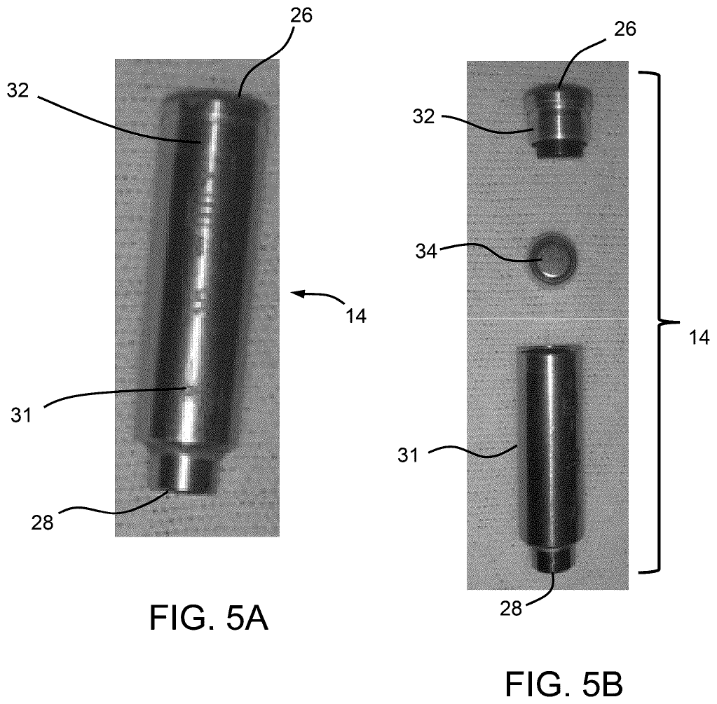

In the embodiment represented in FIGS. 1 through 5B, the body 11 of the laser guide 10 includes an assembly of at least a first member 12 (also referred to herein as the coupling member 12) and a second member 14 (also referred to herein as the emitting member 14). The coupling member 12 includes a shank 16 disposed at a first end 22 thereof and a slot 30 recessed within a second end 24 thereof. In FIGS. 5A and 5B, the emitting member 14 is represented as including a first end 26 configured to be received and releasably retained within the slot 30 of the coupling member 12 and a second end 28 having an aperture 18 from which the laser beam may be emitted. The first end 26 of the emitting member 14 may be retained within the slot 30 at the second end 24 of the coupling member 12 with various mechanisms, such as certain clamping mechanisms. In FIGS. 1 through 5B, the emitting member 14 is shown as retained with a set screw 20, that is, a threaded screw or pin configured to be screwed in a threaded hole such that a tip of the threaded screw contacts and applies pressure against a side of the emitting member 14, thereby clamping the emitting member 14 between the tip of the threaded screw and an oppositely disposed inner wall of the slot 30 of the coupling member 12.

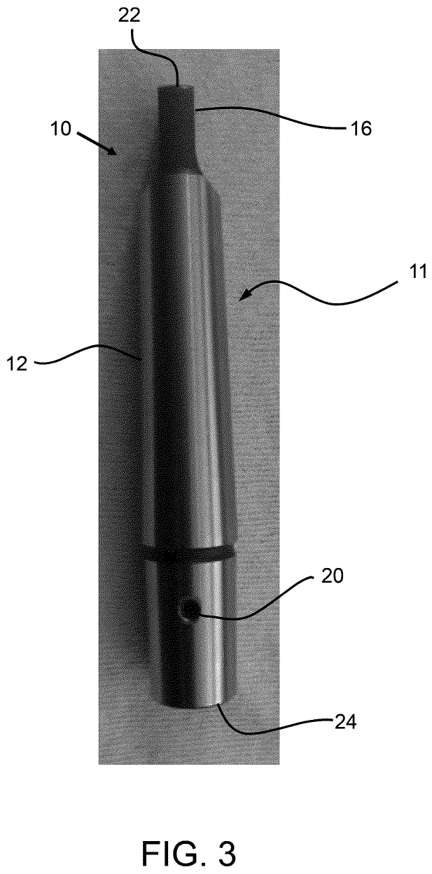

The shank 16 of the coupling member 12 may have various configurations capable of being releasably coupled to the spindle 108 of the drilling machine 100, either directly (e.g., via a machine tapered system) or indirectly (e.g., via the chuck 112). In various embodiments, the shank 16 may be a cylindrical or straight shank, a triangular shank, a hex shank, or another type of shank that is configured to be coupled to the spindle 108 indirectly by the chuck 112 (e.g., a three-jaw chuck) that is configured to directly couple to the spindle 108 and secure the shank 16 thereto with a clamping mechanism. Alternatively, the shank 16 may be configured to be directly coupled to the spindle 108 of the drilling machine 100 with a machine taper system. For example, the shank 16 may be configured as a male member of a Morse taper shank system, such as represented in FIGS. 1 and 3.

Referring to FIG. 5B, the emitting member 14 includes a housing assembly that contains a laser source (not shown; e.g., a laser diode) configured to generate the laser beam, a power source (e.g., one or more batteries) configured to power the laser source, and any other components (not shown; e.g., collimating optics, circuitry, switches, laser diode driver, focusing mechanism, etc.) associated with generating, emitting, and directing the laser beam from the aperture 18 of the emitting member 14. In certain embodiments, one or more of these components may be accessible and/or replaceable. FIGS. 5A and 5B represent the housing assembly of the emitting member 14 as including a main housing 31 that defines the second end 28 of the emitting member 14 and a removable cap 32 adapted to be threaded onto the main housing 31 to define the first end 26 of the emitting member 14. The cap 32 is removable to provide access to an internal compartment within the main housing 31 in which the laser and power sources are contained. Removal of the cap 32 allows for replacement of a battery 34 (i.e., power source) stored within the compartment that provides power to the laser source. Optionally, the emitting member 14 may include an on/off switch or button (not shown) on the housing thereof for activation/deactivation of the laser beam.

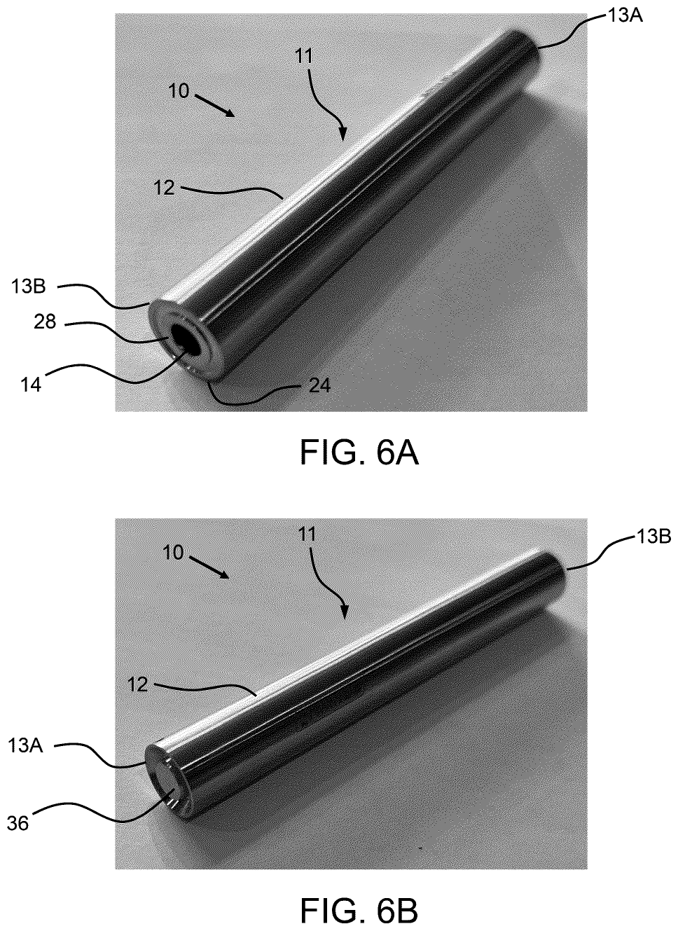

FIGS. 6A and 6B represent an alternative embodiment of the laser guide 10 of FIGS. 1 through 5B. As with the previous embodiment, the body 11 of FIGS. 6A and 6B defines oppositely-disposed first and second ends 13A and 13B of the laser guide 10, the first end 13A is configured to be releasably coupled to the spindle 108 of the drilling machine 100, and the second end 13B is configured to emit a laser beam therefrom so that, when the laser guide 10 is coupled to the spindle 108, an emitted laser beam is directed toward the workpiece 200 along an axial path axially aligned with the axis of rotation 114 of the spindle 108 of the drilling machine 100. The coupling member 12 represented in FIGS. 6A and 6B provides a closed housing that entirely surrounds the emitting member 14 disposed in and at the second end 24 of the coupling member 12, such that only the second end 28 of the emitting member 14 and its aperture (unnumbered in FIG. 6A) are exposed. The first end 13A of the coupling member 12 is represented as equipped with an on/off switch or button 36 for activation/deactivation of the laser beam generated by the emitting member 14. In contrast to the embodiment of the emitting member 14 in FIGS. 5A and 5B, the emitting member 14 may be integrated into the coupling member 12 such that the coupling member 12 directly defines the housing for the laser source and power source of the emitting member 14 (i.e., the emitting member 14 lacks a separate housing, such as the housing assembly of FIGS. 5A and 5B, and the coupling member 12 defines one or more compartments in which the laser source, power source, and on/off switch 36 of the emitting member 14 are disposed), or the emitting member 14 may comprise a housing that is retained within the coupling member 12 (for example, by an interference fit). Optionally, access to the battery 34 may be provided through the on/off switch 36, though the coupling member 12 is not required to be configured to provide access to or replacement of the battery 34.

In embodiments such as represented in FIGS. 6A and 6B, the coupling and emitting members 12 and 14 are not configured to be disassembled without resulting in damage to one or both members 12 and 14. Furthermore, the emitting member 15 does not comprise a threaded assembly (such as the housing assembly of FIGS. 5A and 5B) so that axial alignment of the emitting member 14 with the coupling member 12, and consequently the spindle 108, is not dependent on the accuracy with which components of the housing assembly of the emitting member 14 are manufactured and assembled or the accuracy with which the emitting member 14 is installed and retained in the coupling member 12. As such, a laser spot 38 produced by the laser guide 10 of FIGS. 6A and 6B is capable of greater accuracy when locating a position of a drill bit subsequently secured to the spindle 108.

Each embodiment of the laser guide 10 described above provides for a nonlimiting method of producing a hole in a predetermined portion of a workpiece with a drilling machine. Such a method would generally include positioning the drilling machine in proximity to or, more typically, directly on a workpiece, and then securing the position of the machine relative to the workpiece. The method further includes coupling the shank 16 at the first end 13A of the laser guide 10 to the spindle of the drilling machine. If necessary, the drilling machine can be repositioned so that the spot 38 of the laser beam is radiated on the predetermined portion of the workpiece. The laser beam can then be emitted from the second end 13B of the laser guide 10 such that the laser beam is axially aligned with the axis of rotation 114 of the spindle of the drilling machine. The shank 16 of the laser guide 10 may then be decoupled from the spindle of the drilling machine, and replaced with a drill bit (not shown) by coupling the drill bit to the spindle of the drilling machine. The drill bit may be coupled to the spindle directly (e.g., via a machine tapered system) or indirectly (e.g., via a chuck). The drilling machine may then be operated in a conventional manner to produce a desired drilled hole in the predetermined portion of the workpiece with the drill bit, for example, by activating the electric motor of the drilling machine to rotate the spindle and thereby rotate the drill bit, and then lowering the spindle to thereby lower the drill bit into contact with the workpiece and eventually penetrate the workpiece at the predetermined portion.

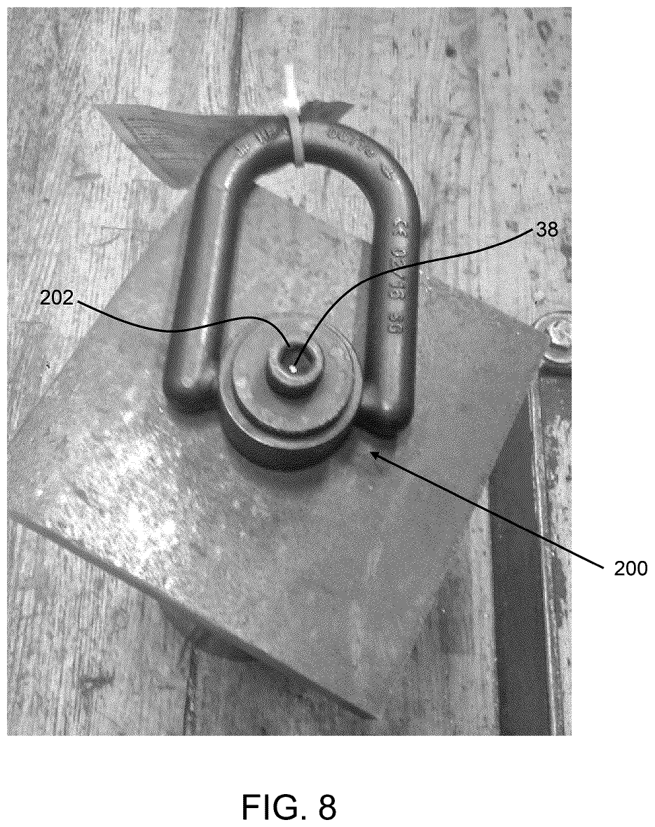

As a nonlimiting example, FIGS. 7 and 8 represent the laser guide 10 of FIGS. 1 through 5B being used to position the portable magnetic drilling machine 100 on a workpiece (for illustrative purposes only, on a table 300 in FIG. 7) relative to a location of the same or a second workpiece (for illustrative purposes only, a separate workpiece 200 in FIG. 7). Initially, the machine 100 was positioned on and magnetically secured to the table 300 (formed of a ferromagnetic material) by energizing the magnetic base 104 of the machine 100 so that the axis of rotation 114 of the spindle 108 was approximately aligned with a cavity 202 in the workpiece 200 where a hole is desired to be drilled with the machine 100. Because the axis of rotation of the drill bit (and the tip thereof) coincides with the axis of rotation 114 of the spindle 108, the laser guide 10 can be secured in the spindle 108 and energized to emit a laser beam whose axis also coincides with the axis of rotation 114 of the spindle 108. The impingement of the laser beam creates a laser spot 38 whose location relative to the workpiece 200 and its cavity 202 allows for precise repositioning of the machine 100 on the table 300 so that the spot 38 is centered on the cavity 202. For this purpose, after energizing the laser guide 10 to generate a laser beam, the magnetic base 104 can be de-energized to permit large and fine adjustments of the position of the machine 100 until the laser spot 38 is centered on the cavity 202 (FIG. 8), thereby confirming that the axis of rotation 114 of the spindle 108 passes through the cavity 202. Thereafter, the magnetic base 104 of the machine 100 is energized to magnetically secure the machine 100 to the table 300, after which the laser guide 10 can be replaced with a drill bit (not shown) and the drill head 106 translated along its translation axis 110 to drill a hole within the cavity 202. In this manner, the laser guide 10 may be used to promote the ease with which a portable drilling machine can be positioned on (or relative to) a workpiece to drill a hole in a specific, predetermined position in the workpiece. The method may further include replacing one or more components of the laser guide 10, such as the laser source or the power source configured to power the laser source.

Coupling the shank 16 to the spindle 108 of the drilling machine 100 may include, for example, receiving and clamping the shank 16 within the chuck 112 of the drilling machine 100. In other examples, coupling the shank 16 to the spindle 108 may include directly coupling the shank 16 to the spindle 108 with a machine taper system, such as but not limited to a Morse taper shank system including that depicted in FIGS. 1 through 5B.

For embodiments such as FIGS. 1 through 5B in which the coupling and emitting members 12 and 14 are configured to be readily disassembled, the method may include locating and releasably retaining the first end 26 of the emitting member 14 within the slot 30 of the coupling member 12. Thereafter, the method may include separating the coupling member 12 and the emitting member 14, for example, to access the battery 34 through the first end 26 of the emitting member 14. This may include removing the cap 32 to access the internal compartment within the emitting member 14.

While the invention has been described in terms of a specific or particular embodiment, it should be apparent that alternatives could be adopted by one skilled in the art. For example, the laser guide 10 and its components could differ in appearance and construction from the embodiment described herein and shown in the figures, functions of certain components of the laser guide 10 could be performed by components of different construction but capable of a similar (though not necessarily equivalent) function, and various materials could be used in the fabrication of the laser guide 10 and/or its components. Accordingly, it should be understood that the invention is not necessarily limited to any embodiment described herein. It should also be understood that the phraseology and terminology employed above are for the purpose of describing the disclosed embodiment, and do not necessarily serve as limitations to the scope of the invention.

1. A laser guide for a drilling machine, the laser guide comprising:
a body;
a laser source configured to generate a laser beam;
a first end of the body configured to be releasably coupled to the spindle of the drilling machine; and
a second end of the body configured to emit the laser beam such that the laser beam is axially aligned with an axis of rotation of the spindle of the drilling machine when the first end is coupled to the spindle.

2. The laser guide of claim 1, further comprising a power source within an internal compartment of the body and configured to provide sufficient power the laser source to generate the laser beam.

3. The laser guide of claim 2, wherein the body is configured to provide access to the compartment and the power source therein is configured to be replaceable.

4. The laser guide of claim 1, wherein the first end of the body is configured to be coupled to the spindle of the drilling machine with a chuck of the drilling machine.

5. The laser guide of claim 1, wherein the first end of the body includes a shank that is configured to be directly coupled to the spindle of the drilling machine with a machine taper system.

6. The laser guide of claim 5, wherein the shank is configured as a male member of a Morse taper shank system.

7. The laser guide of claim 1, wherein the body comprises:
a coupling member having a shank at a first end thereof and a slot at a second end thereof;
an emitting member comprising the laser source and a power source configured to provide sufficient power to the laser source to generate the laser beam, the emitting member being enclosed within the slot of the coupling member so that only an end of the emitting member is exposed from which the laser beam is emitted;
wherein the coupling member and the emitting member are not configured to be disassembled from each other.

8. The laser guide of claim 7, wherein the coupling member defines a compartment in which the laser source and the power source are disposed.

9. The laser guide of claim 7, wherein the first end of the coupling member is equipped with an on/off switch for activation and deactivation of the laser beam generated by the emitting member.

10. The laser guide of claim 1, wherein the body comprises:
a first member having a shank at a first end and a slot at a second end;
a second member having an internal compartment storing the laser source and a power source configured to provide sufficient power to the laser source to generate the laser beam, the second member having a first end configured to be received and releasably retained within the slot of the first member and a second end from which the laser beam is emitted;
wherein the first member and the second member are configured to be releasably coupled together.

11. The laser guide of claim 10, wherein the first end of the second member is configured to provide access to the internal compartment for replacement of the power source when the first member and the second member are separate.

12. The laser guide of claim 10, wherein the first member is configured to retain the second member within the slot with a set screw.

13. A method of drilling a predetermined portion of a workpiece with a portable magnetic drilling machine, the method comprising:
locating and magnetically securing the portable magnetic drilling machine in a first position relative to the workpiece;
coupling a first end of a laser guide to a spindle of the portable magnetic drilling machine;
providing power from a power source to a laser source of the laser guide so as to generate a laser beam with the laser source;
while the first end of the laser guide is secured to the spindle, emitting the laser beam from a second end of the laser guide, the laser beam being axially aligned with an axis of rotation of the spindle of the portable magnetic drilling machine and radiating a spot on the workpiece with the laser beam;
if necessary, relocating the portable magnetic drilling machine relative to the workpiece such that the spot of the laser beam is radiated on the predetermined portion of the workpiece;
decoupling the first end of the laser guide from the spindle of the portable magnetic drilling machine;
coupling a drill bit to the spindle of the portable magnetic drilling machine; and
operating the portable magnetic drilling machine to produce a hole in the predetermined portion of the workpiece with the drill bit.

14. The method of claim 13, further comprising:
accessing an internal compartment of the laser guide in which the power source is stored; and
removing and replacing the power source.

15. The method of claim 13, wherein coupling the first end of the laser guide to the spindle includes receiving and clamping the first end of the laser guide within a chuck of the portable magnetic drilling machine.

16. The method of claim 13, wherein the first end of the laser guide includes a shank and coupling the first end of the laser guide to the spindle includes directly coupling the shank to the spindle with a machine taper system.

17. The method of claim 16, wherein the shank is configured as a male member of a Morse taper shank system.

18. The method of claim 13, wherein the laser guide includes a first member having a shank at a first end and a slot at a second end and a second member having a first end configured to be received and releasably retained within the slot of the first member and a second end from which the laser beam is emitted, the method further comprising:
locating and releasably retaining the first end of the second member within the slot of the first member.

19. The method of claim 18, further comprising:
separating the first member and the second member;
accessing the power source from the first end of the second member while the first member and the second member are separate.

20. The method of claim 18, further comprising retaining the first end of the second member within the slot of the first member with a set screw.
